(19) United States
(12) Patent Application Publication
(10) Pub. No.: US 2002/0038389 A1
(43) Pub. Date: Mar. 28, 2002

(54) Client/server system, server and client

(76) Inventor: Shigeru Fujita, Kawasaki (JP)

Correspondence Address: STAAS & HALSEY LLP, 700 11TH STREET, NW, SUITE 500, WASHINGTON, DC, 20001, US

(21) Appl. No.: 09/788,540

(22) Filed: Feb. 21, 2001

(30) Foreign Application Priority Data
Sep. 26, 2000 (JP) 2000-291613

(51) Int. Cl. G06F 13/10; G06F 9/46; G06F 15/16

(52) U.S. Cl. 709/321; 709/203; 709/310

(57) ABSTRACT

There are provided a POS client having an I/O device and a POS server for redirecting an event in the I/O device and directly controlling the I/O device.

### CROSS REFERENCE TO RELATED APPLICATIONS

The present application claims priority under 35U.S.C. 119 to Japanese Patent Application No. 2000-291613, filed Sep. 26, 2000, entitled “Client Server System, Server and Client”. The contents of that application are incorporated herein by reference in their entirety.

### BACKGROUND OF THE INVENTION

### FIELD OF THE INVENTION

The present invention relates to the structures of a client/server system, and a server and a client therefor. Specifically, the present invention aims at improving the processing speed in a client/server system, and a server and a client therefor, which are configured to reduce hardware resources on a client side. More specifically, the present invention aims at providing new arrangements to a client/server system, and a server and a client therefor, wherein a World Wide Web system is utilized.

### DESCRIPTION OF THE BACKGROUND

In recent years, client/server systems with the World Wide Web system adopted as a platform thereof have been widely employed. The World Wide Web system is a system to perform the provision of information on Internet. The system includes one or plural Web servers (server machines) 1a for providing information, and plural clients 2a including a browser 2 for obtaining required information as shown in FIG. 7.

The common flow of the provision of information in such a system structure is that, in response to a demand from the browser 20 of a client 2a, the information, such as an HTML (Hyper Text Markup Language) document, demanded by the client side 2a is transferred to the browser 20 from the Web server 1a through HTTP protocol (Hyper Text Transfer Protocol) communication, and the information is displayed on the screen of the browser.

The reason why client/server systems with the World Wide Web system adapted as a platform thereof have been widely employed is that the following merits are provided:

1) It is easy to change or modify an application since the application is installed on a server side 1a and since the application runs on the server side 1a. On the other hand, client/server systems with an application installed on clients 2a are costly in terms of management and operation since any change or modification in the application is required to be carried out throughout all clients 2a.

2) It is possible to reduce the hardware cost on the client side 2a since the execution of the application by the server side 1a allows the client side 2a to be diskless, for instance. In particular, systems with many clients 2a can reduce the system cost.

From the reasons 1) and 2), the client/server systems with the World Wide Web system adopted as a platform thereof can reduce TCO (Total Cost of Ownership).

In FIGS. 8 and 9 are shown an example of the structure wherein a client/server system with the World Wide Web system adopted as a platform thereof is employed in a POS system. Specifically, the client/server system includes a web server 1a with a POS application 10, such as a database, installed thereon, and a client 2a with a browser 20 installed thereon (plural clients may be provided as shown in FIG. 8 though a single client is shown in FIG. 9). The web server 1 and the client 2a are connected through a certain communication channel, such as a LAN (Local Area Network). The client 2a is connected to at least one I/O device 4 through an OS 6 for POS.

Examples of the I/O device 4 are a bar code reader (scanner) for reading a bar code or another code, a customer display for displaying required information to a customer or a client operator, a journal/receipt printer for recording a transaction history and issuing a receipt to a customer, and a cash drawer.

The OS 6 for POS controls the I/O device 4, or receives an event in the I/O device and carries out input-output processes to the browser 20 based on the received event. The browser 20 requests the POS application 10 of the web server 1a to provide required information through an HTTP protocol or another protocol. The web server 1a returns the result of the processing by the POS application 10 to the browser 20 of the client 2a in a DHTML (Dynamic Hyper Text Markup Language) form or another form through HTTP protocol communication. In the client 2a, the browser 20 performs the display of the result of the processing or another process as required. The browser 20 has a script preincluded to perform required processes. The procedures that are described in the script are sequentially read out and performed.

However, the processing in such a system creates the following problems in terms of a Price Look Up (PLU) process or another process:

1) The processing of the script in the browser side 20 has poor performance, degrading processing efficiency. Examples of the control language that runs on the browser side 20 at present are the Visual Basic Script language (Microsoft's trademark) and the Java Script language (or J-Scrip language; Microsoft's trademark). These languages can not provide desired performance since these languages are not compiled languages, specifically since these languages are script languages that are executed, being subjected to syntax analysis at run time.

2) In order to obtain desired performance, the client side 2a is required to have a high-performance hardware specification (e.g., with regard to a CPU or a memory) since the control of the I/O device 4 is carried out in the client side 2a. This can not cope with demands for a reduction in the hardware cost of the client side 2a. These problems are applied to not only POS systems but also client/server systems in general.

### SUMMARY OF THE INVENTION

It is an object of the present invention to eliminate these problems and to provide the structures of a client/server system, a server and a client capable of preventing processing efficiency from degrading even in the client/server system using a client with hardware resources mitigated.

According to a first aspect of the present invention, there is provided a client/server system comprising a client having at least one I/O device and a server for redirecting an event in the I/O device and directly controlling the I/O device.

By the arrangement of the first aspect, an output of the event in the I/O device on a client side can be redirected to the server to improve processing efficiency since it is possible to eliminate the restrictions in the script processing stated earlier, which has inferior performance. In addition, the client can eliminate an arrangement for controlling the I/O device to mitigate the hardware resources in the client since the server directly controls the I/O device.

According to a second aspect of the present invention, there are provided an entire structure of the client/server system with an interface between the client and the server included therein, specifying the arrangement provided by the first aspect.

Specifically, the arrangement provided by the second aspect is characterized in that the client/server system comprises the client and the server, that a server side includes a device driver for controlling an I/O port on a client side, and a virtual I/O port for providing the device driver with an interface having the same function as the I/O port, transmitting a control signal from the device driver to the client side and informing the device driver of an event received from the client side, and that the client side includes at least one I/O port connectable with the I/O device, and a device handler for communicating with the virtual I/O port to control the I/O port, wherein the event in the I/O device on the client side is redirected to the virtual I/O port on the server side, and the device driver on the server side directly controls the I/O device on the client side.

As explained, by communication between the virtual I/O port and the device handler, the I/O port on the client side is controlled by the device driver on the server side, and the event in the I/O device outputted from the I/O port is transmitted to the device driver. Thus, the I/O device on the client side is controlled as if the I/O device is directly connected to the server side. In this manner, the event in the I/O device on the client side is directly transmitted to, e.g., an application on the server side, improving the processing efficiency in the entire system. Since the I/O device is controlled by the device driver on the server side, the client side can eliminate an arrangement for controlling the I/O device, mitigating the hardware resources in the client.

When the event in the I/O device on the client side is inputted into the server side, the process flow on the server side is as follows: The event in the I/O device, which is redirected from the client side directly to the server side, is transmitted to the application through an OS for management, and the result of the processing by the application is outputted to the client side from the server side. Specifically, the event in the I/O device on the client side is transmitted to the application through the virtual I/O port, the device driver and the OS for management and is processed by the application on the server side. The result of the processing is transmitted to the client side by a separate system from the communication between the virtual I/O port and the device handler stated earlier, and processing, such as displaying on the client side, is carried out as required. The output of the result of the processing by the application may have the same form as the conventional one. When the World Wide Web system is adopted, the result of the processing is directly returned to the browser by way of socket communication (TCP/UDP) or other measures to display the result of the processing on the client side.

According to a third aspect of the present invention, there is provided an arrangement that is grasped from the server side with respect to the arrangement for the client/server system according to the first aspect. Specifically, the arrangement of the server is characterized by redirecting the event in the I/O device transmitted from the client side and directly controlling the I/O device.

When the client/server system according to the second aspect is grasped from the server side, the arrangement is as follows: Specifically, the server is configured to include the device driver for controlling the I/O port on the client side and the virtual I/O port for providing the device driver with an interface having the same function as the I/O port, transmitting a control signal from the device driver to the client side and informing the device driver of the event received from the client side, while the client including the device handler for controlling the I/O port connectable with the I/O device, wherein the event in the I/O device transmitted from the client side is redirected to the virtual I/O port, and the device driver directly controls the I/O device.

According to a first modification stated later on, the arrangement for the client/server system that is grasped from the server side is as follows: Specifically, the server is configured to at least include an OS for management for receiving the event in the I/O device redirected from the client side, and an application having the event inputted thereinto through the OS, wherein the result of the processing by the application is outputted to the client side.

According to a fourth aspect of the present invention, there is provided an arrangement that is grasped from the client side with respect to the arrangement for the client/server system according to the first aspect. Specifically, the client is characterized by including at least one I/O device, redirecting an event in the I/O device to the server side, and directly controlling the I/O device by the server side.

According to fifth aspect of the present invention, there is provided an arrangement that is grasped from the client side with respect to the arrangement for the client/server system according to the second aspect. Specifically, the client is configured to include at least one I/O port controlled by a device driver and connectable with an I/O device, and a device handler communicating with a virtual I/O port to control the I/O port, the virtual I/O port being included in a server to provide the device driver with a certain interface, transmit a control signal from the device driver and inform the device driver of a received event, wherein the event in the I/O device is redirected to the virtual I/O port on the server side, and the I/O device of the client is directly controlled by the device driver on the server side.

The arrangement that is grasped from the client side with respect to the client/server system proposed as the first modification is as follows: Specifically, the client is configured to redirect the event in the I/O device and to perform a certain process in response to the result of the processing by the application on the server side, while the server includes an OS for management and an application to run on the OS.

It is needless to say that the proposed arrangements are also applicable to a case wherein the World Wide Web system is used as a platform.

As explained, in accordance with the client sever system of the first aspect to the fifth aspect, the client side can become free from a processing load for a I/O device connected to the client, the processing that has conventionally been performed in the I/O device can be directly performed on the server side, and the script processing on the client side conventionally required for the processing in the I/O device, for instance, can be eliminated, offering a superior advantage to improve system performance.

Since the server can control the I/O device, the client can be formed from inexpensive hardware resources, and management cost can be reduced.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a structure of the client/server system according to an embodiment of the present invention;

FIG. 2 is a block diagram showing a hardware structure in the client/server system;

FIG. 3 is a block diagram showing a software structure in the client/server system;

FIG. 4 illustrates the data-flow between a POS application and an I/O device in the client/server system;

FIG. 5 illustrates an operational sequence in the client/server system;

FIG. 6 illustrates the operational sequence in a conventional client/server system;

FIG. 7 illustrates the structure of a client/server system with the World Wide Web system adopted as a platform;

FIG. 8 illustrates a case wherein the client/server system with the World Wide Web system adopted as a platform is employed in a POS system; and

FIG. 9 is a functional block diagram of the conventional client/server system.

### DESCRIPTION OF THE PREFERRED EMBODIMENTS

The preferred embodiments will be described with reference to the accompanying drawings.

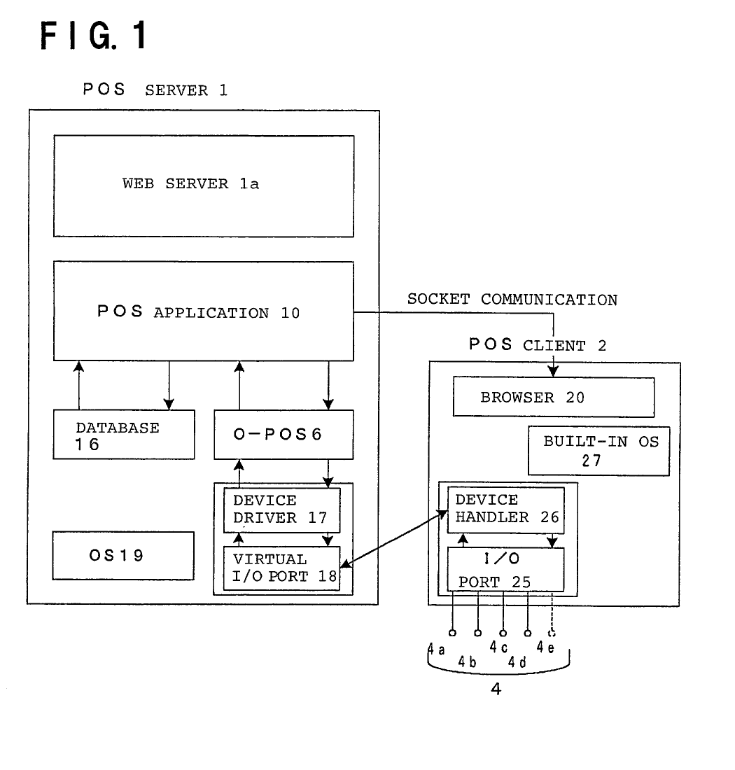

In FIGS. 1-5 is shown an embodiment of the present invention. It is shown that the embodiment is applied to a case wherein a client/server system with the World Wide Web system used as a platform is employed in a POS system.

As shown in these figures, the POS system includes a POS server 1 having a POS application 10 (such as a database 16) and a web POS server 1a, and a POS client 2 having a browser 20 (although only one POS client is shown, a plurality of POS client may be provided). The POS server 1 and the POS client 2 are connected through a LAN (Local Area Network).

The POS client 2 includes a bar code reader 4a for reading a bar code or another code, a customer display 4b for displaying representations required for a customer or an operator of the POS client, a journal/receipt printer 4c for recording a transaction history and issuing a receipt to a customer, a cash drawer 4d, and another device as I/O devices 4.

In the POS system, the POS server side 1 includes input-output control software 6 for POS (OLE for Retail POS: O-POS), which controls the I/O devices 4 and receives an event in the I/O devices 4, and the number of which is the same as the number of POS clients 2. Based on an event received from an I/O device 4, the O-POS 6 performs input-output processes to the POS application 10.

Between the POS application 10 and the I/O devices 4 of the POS client 2 is an arrangement that redirects an event in an I/O device 4 on the POS client 2 and directly controls the I/O devices 4 by the POS server 1. This arrangement will be described later on.

On the other hand, the result of the processing by the POS application 10 are returned to the browser 20 of the POS client 2 from the POS server 1 through socket communication (TCP/UDP). In the POS client 2, the browser 20 performs a required processes, such as display of the result of the processing. In the browser 20, a script has been preincluded to perform necessary processing, and the procedure described in the script is sequentially read out, performing required processes, such as display of the result of the processing.

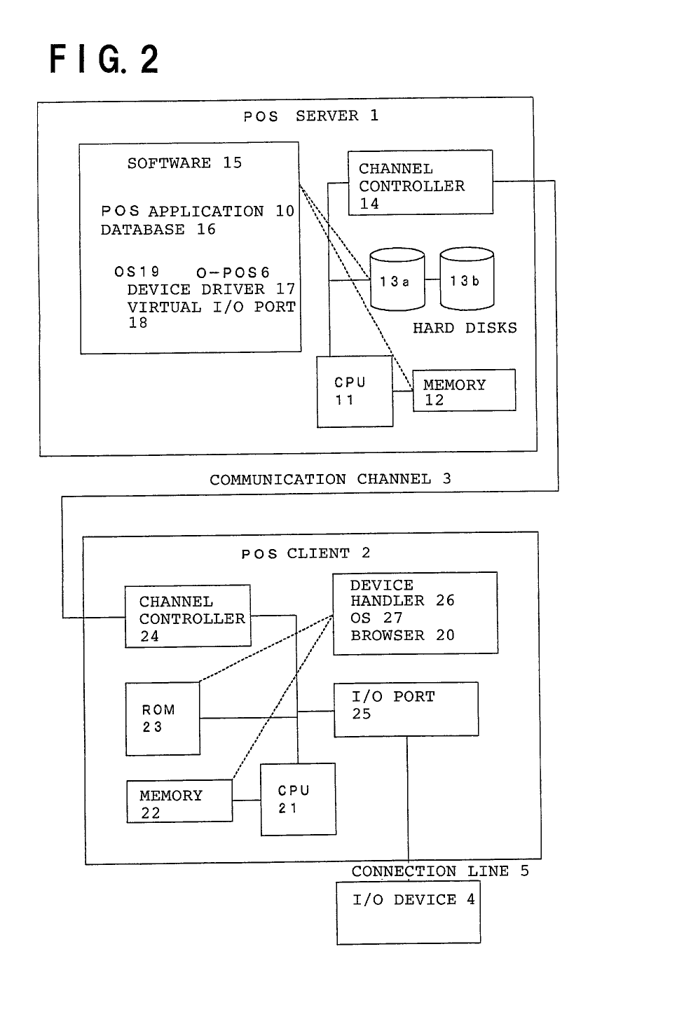

The POS server 1 comprises a CPU 11, a memory 12, hard disks 13a, 13b, and a channel controller 14 as shown in FIG. 2. The hard disks 13a, 13b in a dual configuration have the O-POS 6 conventionally provided on the POS client side 2, a device driver 17, a virtual I/O port 18 explained later on, and an OS 19 in addition to the POS application 10 incorporated thereinto as software 15.

The POS client 2 comprises a CPU 21, a memory 22, a ROM 23, a channel controller 24 and an I/O port 25. In the system, the O-POS 6 and the device driver 17 are provided on the POS driver side 1. In order to operate the O-POS 6 and the device driver 17 by the POS server side 1, software that can convert a signal transmitted from the device driver 17 on the POS server side 1 through a communication channel 3 so as to input the signal into the I/O port 25, i.e., a device handler 26, a built-in OS 27 for controlling the entire POS client 2, and the browser 20 running under the OS 27 are stored in the ROM 23. The detailed functions of the device handler 26 will be stated later on.

It is not necessary to run the POS application in the POS client 2, and it is enough to run only the browser 20 in the POS client. Since the code size of the entire software including the device handler 26 and the OS can become significantly smaller than the conventional system, and the entire software can be stored in the ROM 23 without difficulty. Under the circumstances, no hard disk is required in the POS client 2.

In the conventional server/client system, the major cause of failure on the client side is a hard disk. This means that the system according to the present invention can greatly improve the reliability of the system by eliminating a hard disk.

One example of the communication channel 3 is a LAN (Local Area Network).

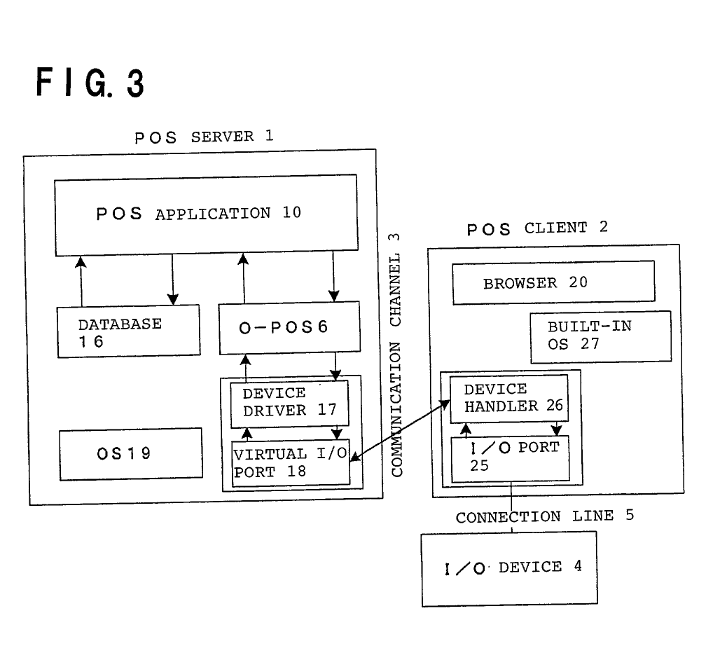

In FIG. 3 is shown a block diagram of the software structure of the POS system shown in FIG. 2. In the system according to this embodiment, the POS server 1 includes the O-POS 6, the POS application 10 including the database 16, the device driver 17 for driving various kinds of I/O devices 4, the virtual I/O port 18 for converting a signal from the device driver 17 into a signal transmittable on the communication channel 3 and converting a signal inputted through the communication channel 3 so as to input the signal into the device driver 17, and the OS 19 for controlling these pieces of software. With regard to the OS 19, an OS that is similar to the one conventionally used when these pieces of software are provided in the POS client 2, i.e., Windows 98 (trademark), Windows NT (trademark), Windows 2000 (trademark) or another existing OS is applicable. With regard to the O-POS 6, the POS application 10 including the database 16 and the device driver 17, it is needless to say that the ones conventionally used in the existing systems are applicable.

The POS client 2 includes the device handler 26, which converts a signal inputted through the communication channel 3 into a signal recognizable at the I/O port 25, and which converts a signal from the I/O port 25 into a signal transmittable through the communication channel 3. In accordance with the present invention, the OS 27 for controlling the POS client may be a built-in OS having a significantly simple structure since the POS client side 2 includes only the device handler 26 having small code size as software and the browser 20 without including an application having great code size (except for the browser 20) or a device driver.

The virtual I/O port 18 in the POS server 1 basically has the following functions. Specifically,

(1) to provide the device driver 17 in an upper stage with an interface to have the same function as the I/O port 25 on the POS client side 2,

(2) to transmit input-output control signals from the device driver 17 to the device handler 26 of the POS client 2, and to inform the device driver 17 of an event received from the device handler 26.

The minimum required functions for the device handler 26 on the POS client side 2 are to receive input-output control signals transmitted from the virtual I/O port 18 of the POS server 1, to perform input control/output control for the I/O port 25, and to transmit an event from the I/O port 25 to the virtual I/O port 18 of the POS server 1.

In the POS system according to this embodiment, the POS server side 1 and the POS client side 2 include the virtual I/O port 18 and the device handler 26, respectively, as stated earlier. The hardware resources of the POS client 2 can be significantly reduced since the POS server side 1 can take over some operations without modifying a conventional application and a conventional device driver.

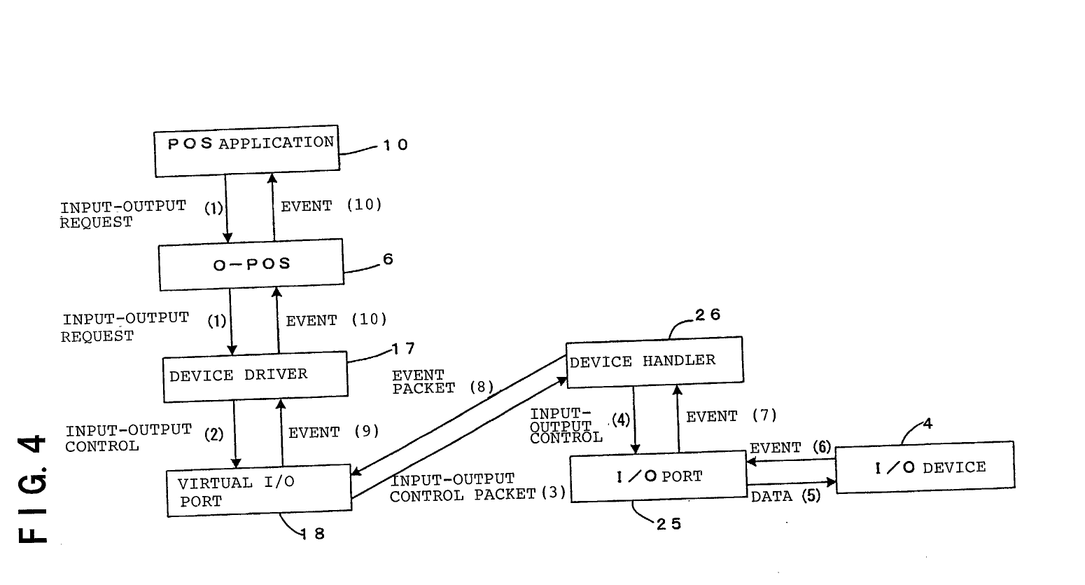

Now, the detailed structure and the operation of the system will be explained, referring to FIG. 4 showing the data-flow between the POS application 10 in the POS server 1 and the I/O devices 4.

First, the input and output of data from the POS application 10 to an I/O device 4 are as follows:

(1) The POS application 10 submits an input-output request (1) including data to be inputted and outputted to the device driver 17 through the O-POS 6.

(2) The device driver 17 performs input-output control (2) for the virtual I/O port 18 in accordance with the input-output request (1).

(3) The virtual I/O port 18 converts the input-output control (2) into data on the communication channel 3 and transmits the data to the device handler 26 on the POS client side 2 in a form of input-output control packet (3).

(4) When the device handler 26 receives the input-output control packet (3), the device handler interprets the contents of the packet and performs input-output control (4) for the I/O port 25.

(5) The I/O port 25 converts the input-output control (4) into data (5) on a connection line 5 and transmits the data to the external I/O device 4 to control it.

Thus, the POS application 10 performs the inputoutput control for the I/O device 4.

Next, the informing of an event from the I/O device 4 to the POS application 10 will be explained.

(6) The I/O device 4 outputs an event (such as a change in a control signal line) (6) on the connection line 5.

(7) The device handler 26 converts an event (7) from the I/O port 25 into data on the communication channel 3 and transmits the data to the virtual I/O port 18 in a form of event packet (8).

(8) When the virtual I/O port 18 receives the event packet (8), the virtual I/O port interprets the contents of the event packet and gives the resultant event (9) to the device driver 17.

(9) The device driver 17 gives the resultant event (10) to the POS application 10 through the O-POS 6.

This is the data-flow between the POS application 10 and the I/O devices 4 in the POS system.

As stated earlier, the POS system has such an arrangement that the POS server side 1 and the POS client side 2 include the virtual I/O port 18 and the device handler 26, respectively, that the control from the device driver 17 as a higher rank with respect to the virtual I/O port 18 is transmitted to the device handler 26, and that the device handler 26 controls the I/O port 25 and transfers an event from the I/O port 25 to the virtual I/O port 18. By this arrangement, the O-POS 6 and the device driver, which have conventionally been operated on the POS client side 2, can be operated on the POS server side 1 without modifying the O-POS 6 and the device driver. Thus, the POS client side 2 can have the burden required for processing extremely reduced, eliminating the need for being equipped with a high capacity storage unit, such as a hard disk.

In the POS system stated earlier, the I/O port 25 of the POS client 2 is connected to the virtual I/O port 18 through the device handler 26 and the communication channel 3. At the time of a Price Look Up process, the following processing will be made.

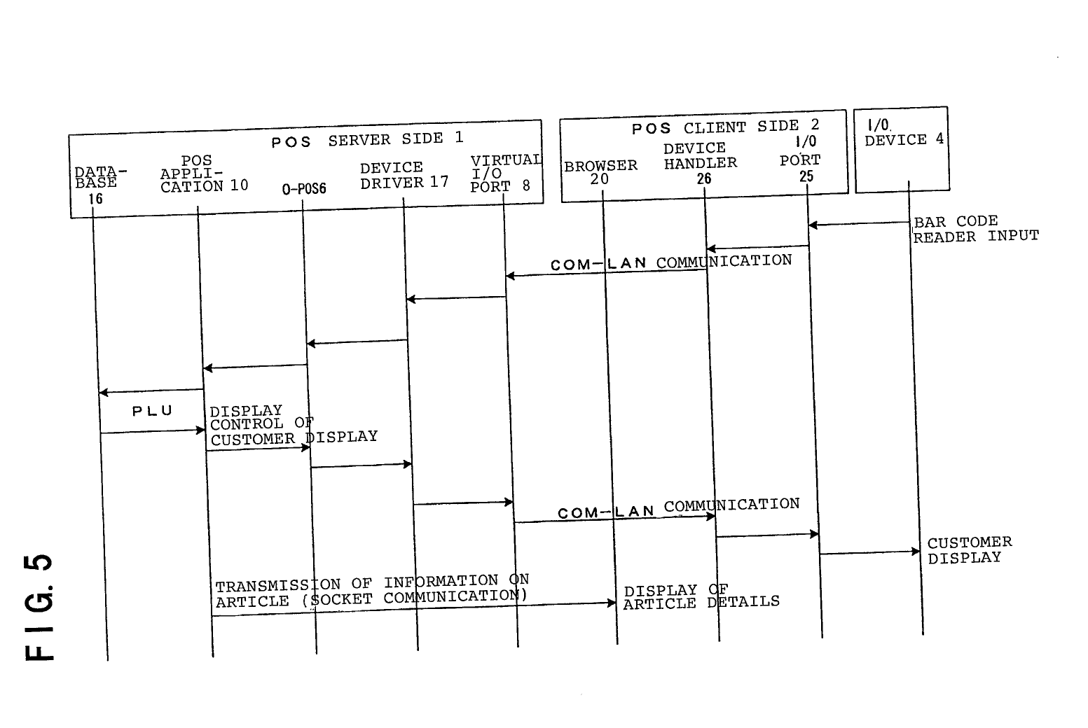

In FIG. 5 is shown an operational sequence in a case wherein article data represented as a bar code is read by the bar code reader 4a on the POS client side 2, the Price Look Up (PLU) process is performed on the POS server side 1, and the representation of article details as the result of the processing is returned to the POS client side 2 to be displayed. First, the bar code reader 4a of the POS client 2 scans the bar code. Then, the event that has been inputted the I/O port 25 of the POS client 2 is inputted into the virtual I/O port 18 on the POS server side 1 through the device handler 20 and the communication channel 3 (COM-LAN communication shown in this figure). The event that has been inputted into the virtual I/O port 18 of the POS server 1 is processed at the O-POS 6 through the device driver 17 and is received by the POS application 10 on the POS server side 1.

The POS application 10 on the POS server side 1 retrieves information on the article from the database 16 according to the inputted bar code data.

On the other hand, the POS application 10 inputs a display control command for a customer display to the O-POS 6, and the command traces the path stated earlier in the reverse direction to be redirected to the I/O port 25 through the communication channel 3 (COM-LAN communication shown in this figure), performing the display control for the customer display. The data, such as the article name and the article price, which have been retrieved as the result of the processing by the POS application 10 are returned to the browser 20 in the form of socket communication to be displayed on the customer display of the POS client 2.

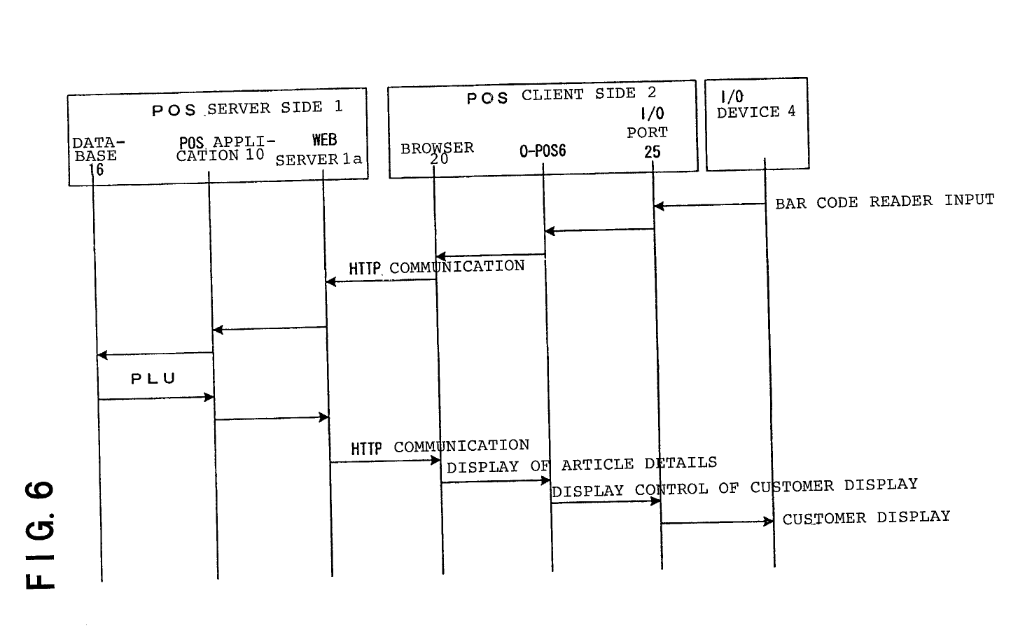

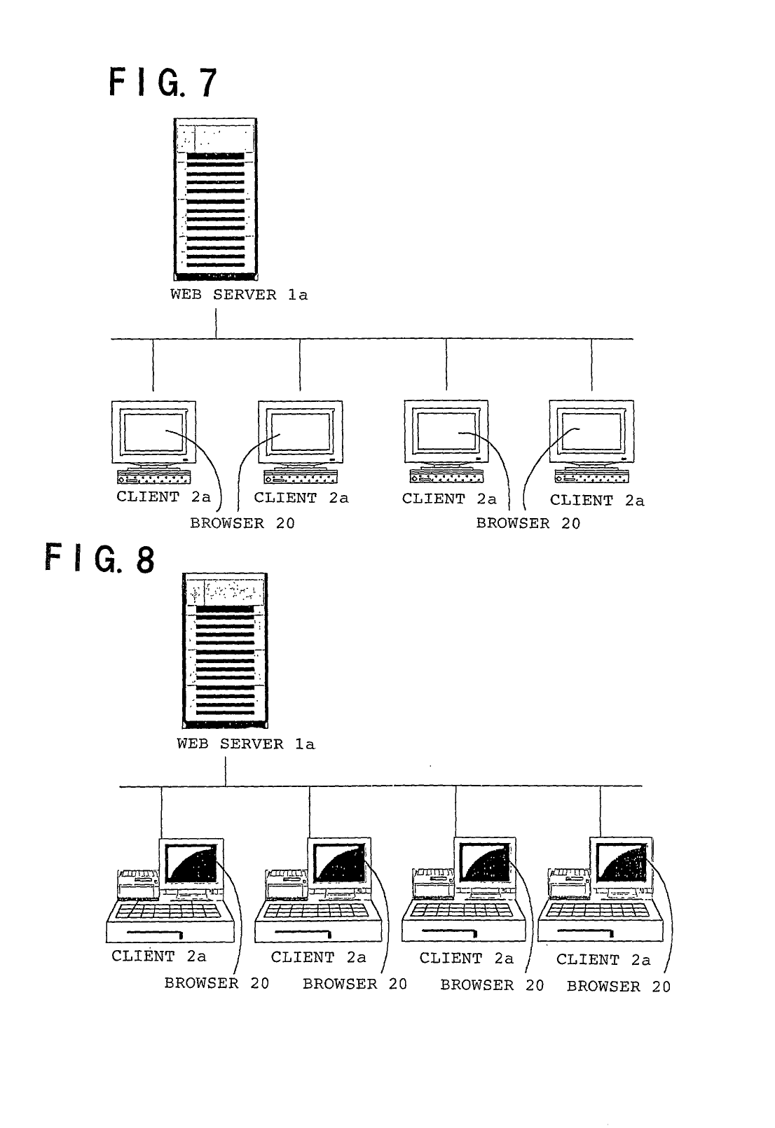

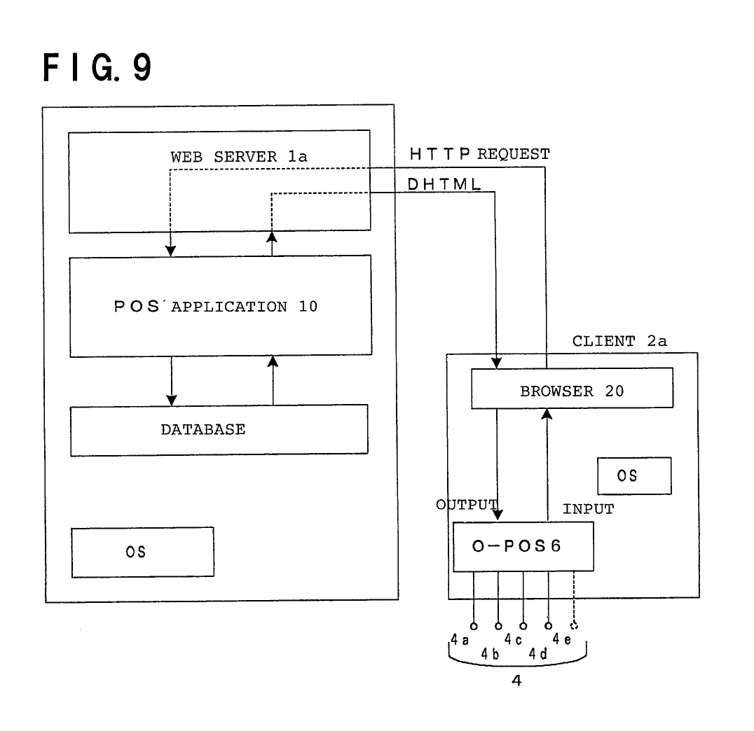

In FIG. 6 is shown the operational sequence in the prior art for the purpose of comparison with the operational sequence in the embodiment shown in FIG. 5. In the prior art, the client side 2a is required to have a high-performance of hardware specification since the control of the bar code reader 4a and another device is performed on the client side 2a.

The POS system according to the present invention is not limited to the embodiment stated earlier. It is needless to say that variations and modifications are possible without departing the sprit of the invention.

For example, the following modifications are proposed:

First Modification

The client/server system according to the first aspect or the second aspect, wherein the event in the I/O device redirected from the client side directly to the server side is transmitted to an application through an OS for management, and the result of the processing by the application is outputted to the client side from the server side.

Second Modification

The client/server system according to any one of the first aspect, the second aspect and the first modification, wherein the server and the client have the World Wide Web system used as a platform therefor.

Third Modification

The client/server system according to the third aspect, further comprising a device driver for controlling an I/O port of a client, and a virtual I/O port for providing the device driver with an interface having the same function as the I/O port of the client, transmitting a control signal from the device driver to the client side, and informing the device driver of the event in the I/O device received from the client side, the client including a device handler for the I/O port thereof connectable to the I/O device, wherein the event in the I/O device transmitted from the client side is redirected to the virtual I/O port, and the device driver directly controls the I/O device.

Fourth Modification

The client/server system according to the third aspect or the third modification, further at least comprising an OS for management for receiving the event in the I/O device redirected from the client side, and an application for having the event inputted thereinto through the OS, wherein the result of the processing by the application is outputted to the client side.

Fifth Modification

The client/server system according to any one of the third aspect, the third modification and the fourth modification, wherein the World Wide Web system is used as a platform therefor.

Sixth Modification

The client/server system according to the fourth aspect or the fifth aspect, wherein the event in the I/O device is redirected to the server, and certain processing is performed in response to the result of the processing by the application on a server side, the server including an OS for management and an application run on the OS.

Seventh Modification

The client/server system according to any one of the fourth aspect, the fifth aspect and the sixth modification, wherein the World Wide Web system is used as a platform therefor.

What is claimed is:

1. A client/server system comprising:
a client having at least one I/O device; and
a server for redirecting an event in the I/O device and directly controlling the I/O device.

2. The client/server system according to claim 1, comprising the server and the client;
wherein a server side includes a device driver for controlling an I/O port on a client side, and a virtual I/O port for providing the device driver with an interface having the same function as the I/O port, transmitting a control signal from the device driver to the client side and informing the device driver of the event received from the client side;
the client side includes at least one I/O port connectable with the I/O device, and a device handler for communicating with the virtual I/O port to control the I/O port; and
the event in the I/O device on the client side is redirected to the virtual I/O port on the server side, and the device driver on the server side directly controls the I/O device.

3. A server configured to redirect an event in an I/O device transmitted from a client side, and to directly controlling the I/O device.

4. A client comprising at least one I/O device, and configured to redirect an event in the I/O device to a server side to directly control the I/O device by the server side.

5. The client according to claim 4, further comprising at least one I/O port controlled by a device driver and connectable with an I/O device, and a device handler communicating with a virtual I/O port to control the I/O port, the virtual I/O port being included in a server to provide the device driver with a certain interface, transmit a control signal from the device driver and inform the device driver of a received event; wherein the event in the I/O device is redirected to the virtual I/O port of the server, and the I/O device of the client is directly controlled by the device driver of the server.
